(19) United States
(12) Patent Application Publication
(10) Pub. No.: US 2026/0192270 A1
(43) Pub. Date: Jul. 9, 2026

(54) CALCINATION APPARATUS AND PROCESSES

(71) Applicant: THE UNIVERSITY OF ADELAIDE, Adelaide (AU)

(72) Inventors: Eyad AL SMADI, Blair Athol (AU); Bassam DALLY, Thuwal (SA); Mehdi JAFARIAN, Adelaide (AU); Graham Jerold NATHAN, Adelaide (AU)

(21) Appl. No.: 18/869,609

(22) PCT Filed: May 30, 2023
(86) PCT No.: PCT/AU2023/050456

§ 371 Date: Nov. 26, 2024

(30) Foreign Application Priority Data
May 30, 2022 (AU) 2022901452

(51) Int. Cl. B01J 6/00; B01D 53/26; C04B 2/02; C04B 2/10; C04B 7/36; C04B 7/43; C04B 7/44; C04B 7/47; C04B 111/00; F22B 1/00; F22B 1/08; F22B 33/18; F27B 7/00

(52) U.S. Cl. CPC B01J 6/001; B01D 53/265; C04B 2/02; C04B 2/104; C04B 7/367; C04B 7/432; C04B 7/44; C04B 7/475; F22B 1/003; F22B 1/08; F22B 33/18; B01D 2257/80; B01D 2258/0233; C04B 2111/00019; F27B 7/00; F27M 2003/03

(57) ABSTRACT

A calcination apparatus is disclosed. The calcination apparatus comprises a calciner, a heated steam production apparatus to produce steam and provide heat and steam to the calciner and a separator to receive exhaust gas from the calciner and to condense steam from the exhaust gas and separate CO₂ gas from the water produced from the condensed steam.

The present application claims priority from Australian Provisional Patent Application No. 2022901452 titled “CALCINATION APPARATUS AND PROCESSES” and filed on 30 May 2022, the content of which is hereby incorporated by reference in its entirety.

### TECHNICAL FIELD

The present disclosure relates to calcination processes.

### BACKGROUND

Lime is an important industrial chemical because it is used in many applications including food processing, construction, water treatment, iron manufacturing, bauxite processing, pulp/paper, sugar refining, glass and plastics [1, 2]. It is produced by calcination, which is the process of heating mineral ores, such as those containing a carbonate, to a sufficient temperature to cause their thermal decomposition and the release of a gas, such as CO₂ or H₂O. Calcination is also used to produce titanium, alumina, and cement. The release of CO₂ from the limestone itself accounts for approximately 60% of the CO₂ emissions from the production of both lime and cement [3, 4], with the remainder arising from the combustion of fossil fuels to generate heat and power. It is therefore desirable to capture this CO₂ with minimum cost, which typically implies heating the material in the absence of nitrogen derived from air.

Clays are emerging as another important material, because they can be used as alternative, and typically supplementary, cementitious material to Portland cement owing to their property as a hydroxylated material. That is, the calcination of clay releases H₂O instead of CO₂, thereby avoiding the need to capture CO₂. Nevertheless, the increasing pressure on water use around the world to reclaim fresh water. Calcining in the presence of steam is therefore also applicable to clays, since the recovery of steam from the process thereby also recovers the steam released during calcination. Nevertheless, it is desirable to also offer a process advantage to increase the viability of steam recovery.

The calcination of limestone typically occurs at a temperature in the range of 800° C.-950° C. and is shown in Equation 1.

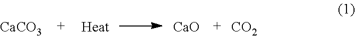

The calcination of clays is more complex, owing to the large number of types of clay, each of which occurs at a slightly different temperature. The release of steam is illustrated by the reaction describing the calcination reaction for kaolinite at between 400° C. and 600° C. below, although a similar release occurs for the other types of clays, albeit at different temperatures for each reaction, as follows:

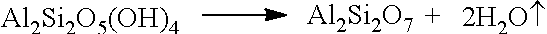

The challenge of capturing CO₂ from the exhaust gases of a standard calcination process is dominated by the high cost of separating the N₂ (one of the combustion products) from the CO₂. One approach to overcome this challenge is to indirectly heat the raw material such that the exhaust stream will only contain CO₂ that is released from the limestone during the calcination [7, 8, 9]. The heat from such a process is presently typically provided by an external combustor but could potentially be provided electrically. This requires the heat from the hot products of the combustion process to be transferred to the calcination medium through the reactor walls which, in turn, requires both more expensive materials and an increase in the size of the reactor, both of which add to cost. Furthermore, isolating the combustion product from the calciner increases the CO₂ partial pressure inside the calciner, which reduces the reaction rate [5, 10, 11, 12] and requires a higher calcination temperature, both of which lead to increased consumption of fuel.

The challenge of capturing steam from calcined clays is similar in that the steam which is released during the calcination process is also mixed with the combustion products, which contain nitrogen from any air used in combustion, together with any CO₂ that would be produced from the combustion of any carbon in the fuel.

Using steam as a calcining medium for limestone has a potential to lower the calcination temperature by both reducing the CO₂ partial pressure and capitalizing on the reported catalytic effect [13, 14], although it is not done commercially. Recent studies on the effect of steam are divided in their view of the role of steam on the CaCO₃ decomposition rate. Some concluded that steam increases the rate of heat transfer between gas (vapour) and solid (limestone particles) [15-17], while others noted the catalytic effects of steam on the surface reactions [18, 19]. Giammaria and Lefferts reported that the reaction rate was enhanced by a factor of four when adding a low percentage of steam (1.25%) to the calcination medium of their reactor [14]. Silakhori et al. measured a reduction in the calcination temperature of 40° C. when using 90% steam and 10% CO₂ as a calcination medium compared to 90% N₂ and 10% CO₂ medium [13]. This suggests that the use of steam as a calcining medium enhances the reaction by inducing a catalytic effect, in addition to its potential to offer a low-cost capture mechanism.

The use of hydrogen as a fuel also has potential to reduce the cost of Carbon Capture, Transport and Sequestration (CCTS) by avoiding the production of CO₂ from the fuel. The cost of CO₂ transport varies depending on the pipe capacity, location (onshore or offshore) and distance of transport. McCoy and Rubin estimated the levelized cost of pipeline transport in five different regions in the USA, Midwest, Northeast, Southeast west and central, to be around US$1.16/ton of CO₂ [20]. The cost of CO₂ storage also varies depending on the geographical location and the method of storage. For example, it has been estimated to cost US$5/ton of CO₂ for onshore depleted oil and gas fields and US$18/ton of CO₂ for offshore saline reservoirs [21-23]. That is, the cost of transport and storage scales with the amount of CO₂ to be sequestered and this can be reduced by lowering the amount of CO₂ generated from a process. Overall, the net benefit depends on the relative cost of hydrogen to the alternative fuel.

The partial pressure of the product for any reaction, including that of calcination, influences the extent of reaction that occurs at a given temperature [5, 10-12]. The reaction only begins when the partial pressure of CO₂ at the solid surface is below the equilibrium decomposition pressure of CaCO₃ which is a function of temperature. Hence, reducing the CO₂ partial pressure will reduce the calcination temperature. This equilibrium pressure for CO₂ can be calculated as follows [5, 6]:

$${P}_{eq} = 4.192 * {10}^{0} {e}^{\frac{- 20474}{T}} , \qquad ( 2 )$$

where P_{eq} is the equilibrium decomposition pressure (kPa) and T is the corresponding calcination temperature (K). To achieve full conversion, P_{CO2}/P_{eq}<0.6 [5]. Hence, any process that lowers the partial pressure of CO₂ will result in lowering the temperature and reducing the energy required per unit mass of limestone.

Another important aspect of efficient and low-cost calcination is to achieve effective heat recovery of the heat in the lime product and transferring this to pre-heat the limestone before it enters the reactor. With present technology, this is done by preheating the combustion air with the hot limestone [24-26]. Since the combustion of hydrogen with oxygen (or using steam generated from water and another source of energy, like concentrated solar thermal energy, electricity or nuclear power, for example) will avoid the use air in the process, an alternative configuration of heat recovery is needed to enable efficient steam calcination.

A range of other types of carbonated and hydroxylated materials, such as clays, also occur naturally and can be processed in a similar way. The use of steam as the reaction atmosphere for clay calcination also offers the advantage of reducing the propensity of the calcined material to deactivation by over-heating. This is advantageous owing to the multi-component nature of clays. The corollary of processing any multi-component mixture in a way that achieves full conversion is that the reaction temperature will exceed the reaction temperature of the component with the lowest reaction temperature, resulting in some de-activation of that component. Processing in steam to reduce this tendency for deactivation is therefore an advantage.

Since steam can be generated by a variety of methods, a plurality of methods with which to generate hot steam can be used to produce the high temperature steam in which to undertake the calcination as alternatives, or supplements, to the combustion of hydrogen with oxygen.

There is a need for an alternative approach for efficient heat recovery using steam calcination. Alternatively, or in addition, there is a need for a new configuration for efficient steam calcination of limestone using H₂/O₂ combustion mixed with recycled steam for cost effective CO₂ capture.

### SUMMARY

According to a first aspect, there is provided a calcination apparatus comprising:
a calciner;
a heated steam production apparatus to produce steam and provide heat and steam to the calciner; and
a separator to receive exhaust gas from the calciner and to condense steam from the exhaust gas and separate CO₂ gas from water produced from the condensed steam.

In certain embodiments of the first aspect, the calcination apparatus further comprises a water recycling system for producing steam from the water recovered from the condensed steam in the separator and feeding the steam product to the calciner.

In certain embodiments of the first aspect, the heated steam production apparatus comprises a combustion apparatus configured to produce steam and heat from oxygen and hydrogen. In other certain embodiments of the first aspect, the heated steam production apparatus comprises a steam generator and a heater configured to produce high temperature steam using a suitable energy source, such as electricity, fuel combustion, concentrated solar thermal, etc.

In certain embodiments of the first aspect, the calcination apparatus further comprises a heat exchanger for producing steam from the water recovered from the condensed steam in the separator using heat from hot exhaust gases from the calciner.

In certain embodiments of the first aspect, the calcination apparatus further comprises a heat recovery system for preheating a raw material to be fed to the calciner.

In certain embodiments of the first aspect, the heat recovery system is configured to transfer heat from hot calcined product to the raw material.

According to a second aspect, there is provided an apparatus for lime (CaO) production, the apparatus comprising the calcination apparatus of the first aspect.

According to a third aspect, there is provided an apparatus for cement clinker production, the apparatus comprising the calcination apparatus of the first aspect and a kiln.

According to a fourth aspect, there is provided an apparatus for production of cementitious material from clay, the apparatus comprising the calcination apparatus of the first aspect.

According to a fifth aspect, there is provided a system for mitigating carbon dioxide levels during the manufacture of lime or cement clinker, the system comprising the calcination apparatus of the first aspect.

According to a sixth aspect, there is provided a system for recovering the steam released from the calcination of a clay to produce a supplementary cementitious material, the system comprising the calcination apparatus of the first aspect.

According to a seventh aspect, there is provided a process for calcining a raw material to produce a calcined product, the process comprising:
introducing the raw material to a calciner; and
heating the raw material in the presence of steam in the calciner to produce a calcined product;
condensing steam from exhaust gas from the calciner; and
where used with a carbonate ore, separating CO₂ gas from the water produced from the condensed steam.

In certain embodiments of the above aspects, the steam used to heat the raw material in the calciner is generated from combustion of oxygen and hydrogen. In certain other embodiments of the above aspects, the steam used to heat the raw material in the calciner is generated using a suitable energy source, such as electricity, fuel combustion, concentrated solar thermal, etc.

In certain embodiments of the above aspects, the process further comprises producing steam from the water recovered from the condensed steam in the separator and feeding the steam product to the calciner.

In certain embodiments of the above aspects, the process further comprises producing steam from the water recovered from the condensed steam in the separator using heat from hot exhaust gases from the calciner.

In certain embodiments of the above aspects, the process further comprises heating the raw material using heat from calcined product exiting the calciner.

### BRIEF DESCRIPTION OF THE FIGURES

Embodiments of the present disclosure will be discussed with reference to the accompanying figures wherein:

FIG. 1 shows a process flow diagram of a prior art reference lime plant without a CO₂ capture process, referred to herein as the ‘reference unmitigated process’. This reference lime plant is the nearest-equivalent to the steam-based cycle and is typical of many industrial dry kiln processes, consisting of a double-stage cyclone preheater, rotary kiln and lime cooler. Many variations are possible, including four-stages of cyclone pre-heating;

FIG. 2 shows a process flow diagram for a prior art oxyfuel process adapted from earlier work [24-26];

FIG. 3 shows a process flow diagram of an embodiment of a steam calcination apparatus and process in which the combustion products of hydrogen and oxygen are used to generate steam and achieve carbon capture with efficient heat recovery. Many variations are possible, including four-stages of cyclone pre-heating;

FIG. 4 shows a process flow diagram of an embodiment of a steam calcination apparatus and process where the combustion products of hydrogen and oxygen mixed with recycled steam are used in a carbon capture process for limestone calcination. Many variations are possible, including four-stages of cyclone pre-heating;

FIG. 5 shows a process flow diagram of another embodiment of a steam calcination apparatus and process where steam is heated electrically before being fed to the calciner, in addition, to an electric steam generator being used to start up the calcination process. Many variations are possible, including four-stages of cyclone pre-heating; and

FIG. 6 compares the XRD patterns of a 1:1 clay sample (a) prior to calcination, (b) calcined under air (no steam) and (c) calcined in 80% steam.

In the following description, like reference characters designate like or corresponding parts throughout the figures.

### DESCRIPTION OF EMBODIMENTS

Details of terms used herein are given below for the purpose of guiding those of ordinary skill in the art in the practice of the present disclosure. The terminology in this disclosure is understood to be useful for the purpose of providing a better description of particular embodiments and should not be considered limiting.

Unless otherwise explained, all technical and scientific terms used herein have the same meaning as commonly understood by one of ordinary skill in the art to which this disclosure belongs.

In the context of the present disclosure, the terms “about” and “approximately” are used in combination with an amount, number, or value, then that combination describes the recited amount, number, or value alone as well as the amount, number, or value plus or minus 20% of that amount, number, or value. By way of example, the phrases “about 40%” and “approximately 40%” disclose both “40%” and “from 32% to 48%, inclusive”.

The singular terms “a”, “an”, and “the” include plural referents unless context clearly indicates otherwise. The term “comprises” means “includes”. Therefore, comprising “A” or “B” refers to including A, including B, or including both A and B. It is further to be understood that all base sizes or amino acid sizes, and all molecular weight or molecular mass values, given for nucleic acids or polypeptides are approximate, and are provided for description.

Although methods and materials similar or equivalent to those described herein can be used in the practice or testing of the present disclosure, suitable methods and materials are described herein. In case of conflict, the present specification, including explanations of terms, will control. In addition, the materials, methods, and examples are illustrative only and not intended to be limiting.

Hills, et al. [8] and Hodgson, et al. [46] have previously developed an indirect steam calcination process by isolating the combustor from the calciner. They stated that up to 60% of the produced CO₂ can be captured when using fossil fuel as the energy source. For indirect calcination, an external combustor is used to isolate the product of combustion from the calcination process. A heat exchanger is used to transfer heat from the hot product of the combustion process to the calcination medium. One of the drawbacks of using indirect calcination is the limited rate of heat transfer through indirect heating, which can lead to significantly high temperatures, especially at the shell surface at the combustion part, in addition to dealing with heat losses. Isolating the combustion product from the calciner also reduces the flow rate of gases inside the calciner which, in turn, can affect the loading of the particles. Also, isolating the combustion product from the calciner increases the CO₂ partial pressure inside the furnace which, in turn, reduces the reaction rate due to a lower reaction driving force.

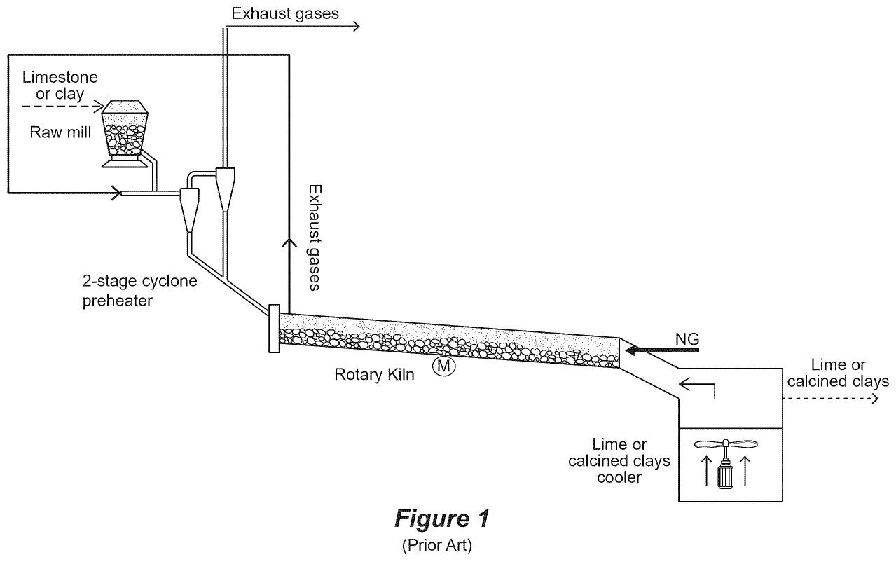

A process flow diagram for a prior art reference lime plant without CO₂ capture or mitigation is shown in FIG. 1. In these conventional kilns, hot air from the lime cooler goes straight to the kiln, to provide a method of recovering heat from the hot lime product. For this configuration, CO₂ emissions are not captured. In the cement industry another configuration is used, where a fraction of the hot air from the lime cooler goes into the kiln as combustion air, the rest is sent to preheaters using a tertiary air duct. The difference between a cement kiln and a limestone calciner is that for cement, an additional step is added after the calciner to heat the particles to 1450° C.

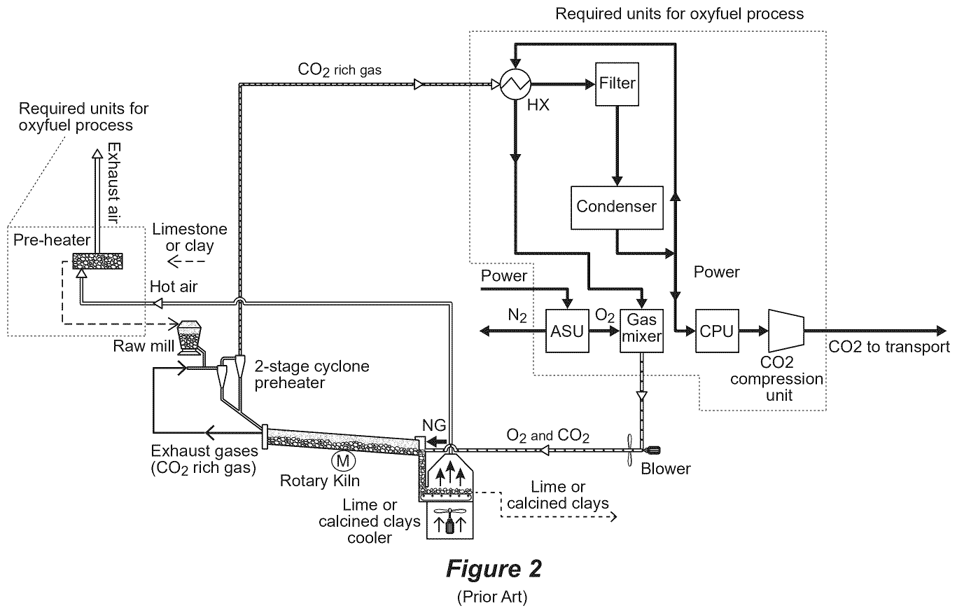

A process flow diagram for a prior art reference lime plant with carbon capture that employs oxyfuel combustion (also referred to herein as the “oxyfuel process”) is shown in FIG. 2. The combustion products of methane and oxygen mixed with recycled CO₂ are used to provide the required heat for the calcination of limestone. Methane is chosen as the reference fuel as a surrogate of natural gas. A pre-heater is chosen to heat the raw material to 400° C. before the mill using recovered heat from the lime cooler. Different types of mills can be used, for example a planetary ball mill (PBM) can operate at high temperatures of up to 600° C. [29-31]. The raw material after the mill is also heated by recovering heat from the exhaust gases, using a double-stage cyclone preheater. The cooled exhaust gases are passed through a carbon purification unit (CPU) and then directed to the compression unit. An air separation unit is used to provide the required oxygen. Nitrogen is not utilized in this process but is proposed to be vented.

Since the air is not sent to the kiln in the oxyfuel process, the energy from the cooler is typically recovered by using this to preheat the raw material. In addition, to reduce the temperature of the flame over that from burning in pure oxygen, recycled CO₂ is typically mixed with the hot products of combustion. With or without this dilution, the only gas in the kiln is CO₂, which results in higher partial pressure of CO₂ inside the kiln relative to the case where combustion is undertaken in air. A higher CO₂ partial pressure results in a higher calcination temperature, which requires more fuel.

In contrast with the prior art processes and apparatus shown in FIGS. 1 and 2, the present inventor(s) has developed a new approach to achieve CO₂ capture from limestone calcination by undertaking the calcination in a steam atmosphere. The steam can be generated by the combustion of hydrogen and oxygen or provided from an external source. This process allows the capture of CO₂ by condensing steam from the exhaust gases which avoids the need for the energy intensive step of separating CO₂ from combustion products that is otherwise needed in conventional plants. To achieve this efficiently, the present inventor(s) has developed a novel way to configure the direct heat exchangers to an existing plant and allow the raw material to be preheated with recovered energy from the hot calcined product. Importantly, this process is retrofittable to a conventional lime process by modifying the pipework between the lime cooler and cyclone pre-heater, together with the burner to accommodate different reactants, because it is a post-combustion capture technology.

The calcination apparatus disclosed herein can be used in any calcination process or process that results in a release of water. As used herein, the term “calcination process”, and related terms, means any process that involves heating a solid material in order to cause chemical separation of its components. Suitable applications include, but are not limited to:

Limestone calcination, where CO₂ is released on heating

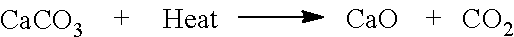

Magnesium carbonate calcination, where CO₂ is released on heating

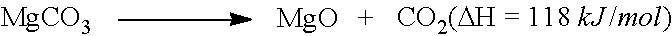

Gibbsite or Boehmite calcination, where H₂O is released on heating

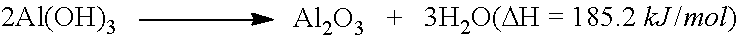

Gypsum or Calcium sulphate dihydrate (CaSO₄·2H₂O) where H₂O is released on heating

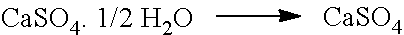

Iron ore with bound water, where the H₂O is released on heating

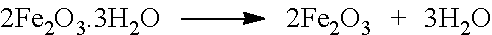

The apparatus and processes disclosed herein can also be used for cement production which involves limestone calcination as a first step and then production of cement clinker from the produced lime.

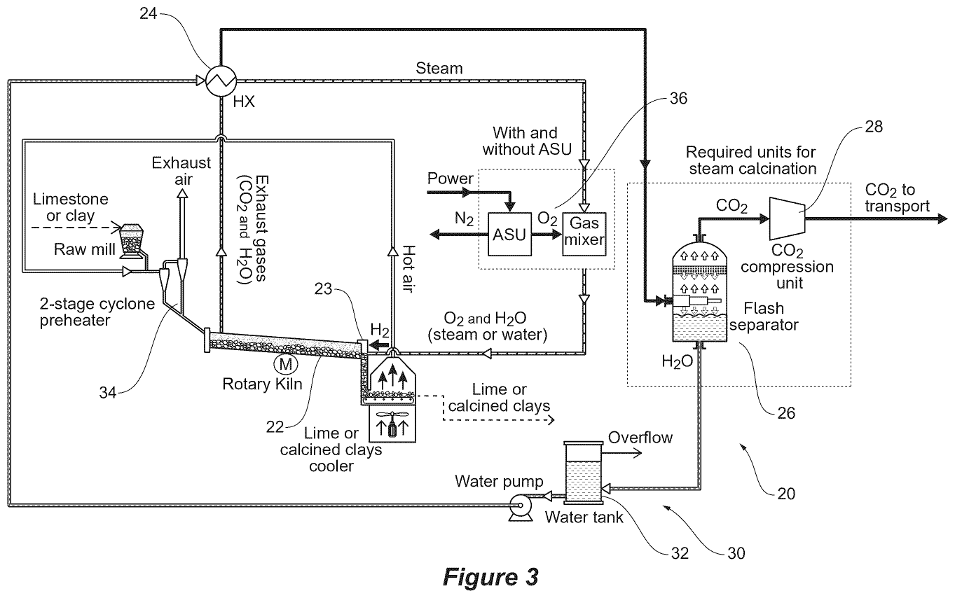

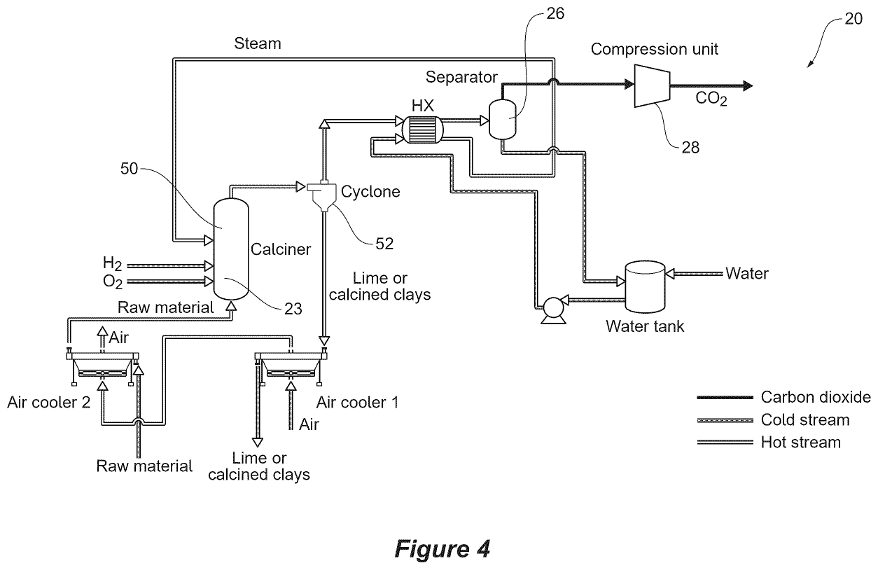

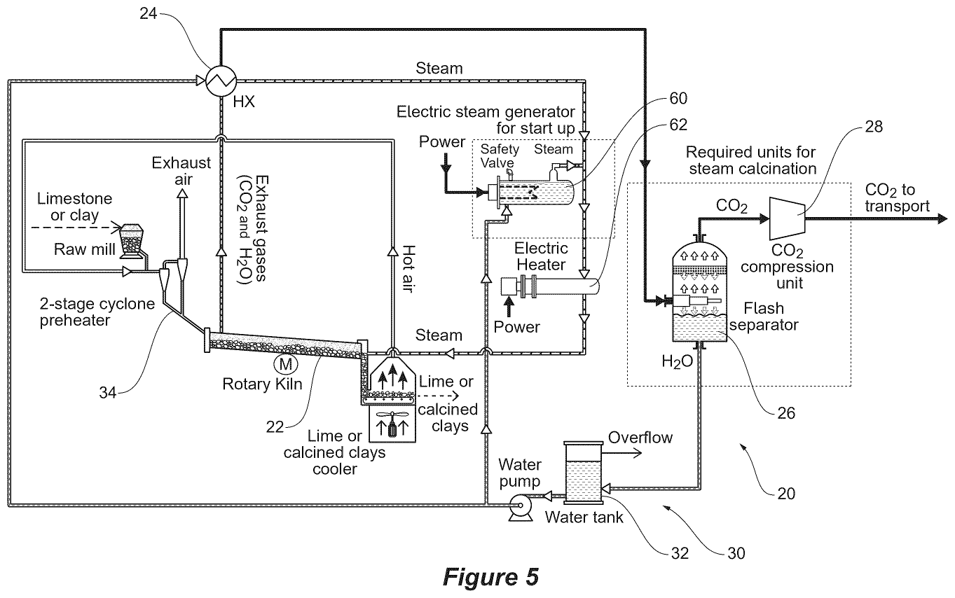

Disclosed herein is a calcination apparatus 20 comprising a calciner 22, a heated steam production apparatus 23 to produce steam and provide heat and steam to the calciner 22, and a separator 26 to receive exhaust gas from the calciner 22 and to condense steam from the exhaust gas and separate CO₂ gas from the water produced from the condensed steam. In the embodiment shown in FIGS. 3 and 4, the heated steam production apparatus 23 comprises a combustion apparatus that produces heat and steam in the calciner 22 from an oxygen feed and a hydrogen feed. In the embodiment illustrated in FIG. 5, the heated steam production apparatus 23 comprises a steam generator 60 for producing steam and a heater 62 for supplying heat to steam before it is fed to the calciner 22.

The calciner 22 may be a rotary kiln, a grate kiln, a shaft kiln, a suspension reactor, a flash reactor or any directly or indirectly heated reactor configuration in which the calcination reaction is performed. Suitable reactors for all of these processes are commercially available in a wide range of configurations, including via various alternative numbers of cyclones used to pre-heat the material before entering the calciner.

A calcination apparatus 20 and process according to an embodiment of the present disclosure is shown in FIG. 3. The apparatus 20 and process enable CO₂ capture via condensation in limestone calcination process. Hydrogen and oxygen are combusted to generate heat required for the calcination reaction, while also producing steam, which is mixed with recirculated steam fed to a calciner 22. A heat exchanger 24 is used to generate steam from the enthalpy in the hot exhaust gases from the calciner 22. The exhaust gases pass through a separator 26 to separate CO₂ as a gas from liquid water. While CO₂ continues to a compression unit 28, water is recovered and recycled through the system using a water recycling system 30. Excess water from the combustion of hydrogen and oxygen is stored in a water tank 32. Steam is produced from the water produced from the condensed steam in the separator 26 and the produced steam is fed to the calciner 22. The heat exchanger 24 is used to produce the steam using heat from hot exhaust gases from the calciner 22. One of the challenges is that this condensation process will result in some of the CO₂ emissions being dissolved into the water. The estimated equilibrium concentration of CO₂ in water at 60° C. is 13.8 g/L. This will generate some carbonic acid, which is corrosive. To overcome this challenge, the solution needs to be neutralised or corrosion-resistant materials, such as stainless steel, need to be used for the flash separator 26 and downstream pipes.

A heat recovery system 34 is used to heat the raw limestone material using recovered heat from the lime. The heat recovery system 34 is a double-stage cyclone preheater in the illustrated embodiment. An air separation unit (ASU) 36 provides the required oxygen.

Importantly, the apparatus 20 and process can be retrofitted to a conventional lime process by modifying the pipework between the lime cooler and cyclone pre-heater 34, together with the burner to accommodate different reactants, because it is a post-combustion capture technology.

FIG. 4 shows an alternative configuration of steam calcination apparatus 20 and process applied to a flash calciner 50. In the flash calciner 50, the material is treated as a fine powder with a short residence time, and a cyclone 52 is used to separate the solid products from the exhaust gases. The exhaust gases pass through a separator 26 to separate the CO₂ from the water.

FIG. 5 shows another configuration of steam calcination apparatus 20 and process. In contrast with the embodiment shown in FIG. 3, in this apparatus and process steam is generated using a steam generator 60 that is external to the calciner 22. Steam generated using the steam generator 60 is mixed with recirculated steam and fed to the calciner 22. A heater 62 is used to supply heat to the steam before it is fed in to the calciner 22. Steam generated using the steam generator 60 can also be fed directly to the calciner 22 at start up and before recirculated steam is available. The steam generator 60 and/or heater 62 can be heated using any suitable energy source, such as electricity, combustion of fuels, concentrated solar thermal, etc. In the illustrated embodiment, the steam generator 60 and heater 62 are heated using electricity. The electricity may be sourced from renewable sources, such as solar power. A heat exchanger 24 is used to generate steam from the enthalpy in the hot exhaust gases from the calciner 22. The exhaust gases pass through a separator 26 to separate CO₂ as a gas from liquid water. While CO₂ continues to a compression unit 28, water is recovered and recycled through the system using a water recycling system 30. Excess water from the combustion of hydrogen and oxygen is stored in a water tank 32. Steam is produced from the water recovered from the condensed steam in the separator 26 and the produced steam is fed to the calciner 22. The heat exchanger 24 is used to produce the steam using heat from hot exhaust gases from the calciner 22. A heat recovery system 34 is used to heat the raw limestone material using recovered heat from the lime. The heat recovery system 34 is a double-stage cyclone preheater in the illustrated embodiment.

Process simulation was performed to analyse the steam calcination process and compare with standard and oxyfuel combustion processes combined with CO₂ capture technology. The process simulation was performed using the commercial software Aspen Plus V11. The IDEAL model was chosen for the thermodynamics and material property interaction, which employs the assumption that the components in a mixture behave ideally in the three phases solid, liquid or vapour.

Table 1 presents the details of the components in the three processes. A stoichiometric reactor was chosen to model the combustion, which is reasonable because the high temperature ensures that the combustion reaction is very fast and irreversible. The equilibrium model is considered for the calciner based on Gibbs free energy minimization with the assumption that this reactor provides enough residence time to achieve equilibrium. A flash separator is chosen to separate CO₂ from water based on the phase.

TABLE 1
Model parameters chosen for each unit in the process simulation.

| Unit | Specification |
|---|---|
| Combustor | Stoichiometric reactor |
| | Working pressure 1 atm and 100% fuel conversion |
| Calciner | Gibbs reactor |
| | Working pressure 1 atm with 10% heat loss |
| Cyclone | 95% separation efficiency |
| Heat exchanger | Approach temperature is 100° C. |
| CO₂ separation | Flash separator, separates based on phase |
| | Working pressure is 1 atm |
| Compression unit | CO₂ delivery pressure is 110 bar |
| | Isentropic efficiency is 88% [32] |
| | Mechanical efficiency is 99% [32] |
| Raw Material | limestone (96.76% wt CaCO₃, 1.18% wt SiO₂, 0.27% |
| | wt Fe₂O₃, 0.20% wt Al₂O₃, 1.03% wt MgCO₃, 0.30% |
| | wt K₂O, 0.06% wt SO₃, 0.12% wt TiO₂, 0.03% wt |
| | SrO, 0.05% wt Na₂O) |

Common design specifications were chosen for the process simulation of all three cases where possible, such as the reactor thermal capacity and the specification of process units. The assumption for power consumption and indirect CO₂ emissions are shown in Table 2.

TABLE 2
The assumption for power consumption
and indirect CO₂ emissions.

| Parameter | Value |
|---|---|
| ASU power demand [33] (kWh/t O2) | 226 |
| ASU cooling demand [34] (kJ/kg O2) | 566 |
| ASU dehydration heat demand [34] (kJ/kg O2) | 58.3 |
| Specific CO₂ emissions of power generation (kg/kWh) | 0-0.5 |

The specific energy requirement was compared for all the three processes (steam calcination process, oxyfuel process and reference unmitigated process), by assuming the same energy input, rather than specifying the production rate, which is set to 60 MW_{LHV}. The particle feed rate was optimized based on the thermal capacity. The combustion of fuel (natural gas or hydrogen) and oxygen as the oxidant were used to provide the required energy for the calcination reaction. The calcination temperature for the three cases is calculated using Equation 2 and a ratio between CO₂ partial pressure and the equilibrium pressure is 0.4, in order to achieve full conversion. The calcination temperature is 920° C. for both the oxyfuel and the reference unmitigated processes. For the steam calcination process, the calcination temperature is 855° C.

Table 3 presents the simulation results for the three processes. It can be seen that with steam calcination, the estimated CO₂ partial pressure is 21.9 kPa which is one third of that for the oxyfuel process. This reduction in partial pressure from 59 to 21.9 kPa·a results in a reduction of the calcination temperature from 920° C. to 855° C. To be conservative, only the effect of CO₂ partial pressure on the calcination process was accounted for without considering the additional catalytic effect of steam on the calcination reaction.

Table 3 also shows that 98.6% of the CO₂ product is captured with the flash condenser. This has no additional energy requirement except for the CO₂ compression unit, which is identical to that of the reference CO₂ capture process. In addition, 90.7% of steam (injected and produced) is recovered. The process efficiency for the steam calcination is 7% higher than that for the oxyfuel process. In the proposed steam calcination process, the mass of steam in the outlet stream of the exhaust gas is slightly higher than that of the recycled water because additional steam is generated through the combustion of hydrogen with oxygen. The enthalpy of the exhaust gas (relative to ambient) is always enough to pre-heat and evaporate the circulated water, typically by a factor of two for generating steam at 700° C. Moreover, 60% of the sensible heat, which accounts for 30% of the total heat of limestone calcination, is recovered from the enthalpy of the lime product.

Furthermore, the quantity of CO₂ to be sequestered is reduced by 23.9% from 46 to 35 ton/hr, by eliminating the fuel-based CO₂ emissions. Assuming a cost of transport and storage that is pro-rata to tonnage (i.e. that the impact of scale is negligible over this range of variation), this will also lower the cost of CO₂ transport and storage by 23.9%.

TABLE 3
Key process data calculated for the three processes.

| | Process simulation results | | |
|---|---|---|---|
| | | | Reference |
| | Steam | Oxyfuel | Unmitigated |
| | calcination | process | process |
| Lime production (ton/hr) | 42.7 | 41.1 | 56.5 |
| Thermal capacity (MW) | 60 | 60 | 60 |
| CO₂ emissions to the atmosphere | 0.51 | 0.14 | 56.5 |
| (ton/hr) | | | |
| CO₂ captured for storage (ton//hr) | 35.4 | 46.1 | — |
| CO₂ partial pressure inside the | 21.9 | 59 | — |
| calciner (kPa, a) | | | |
| CCR (%) | 98.6 | 99.7 | — |
| qₗᵢₘₑ (GJ/ton) | 5.1 | 5.3 | 3.8 |
| Net power consumption (MW) | 7.7 | 10.3 | — |
| ASU (MW) | 3.2 | 3.9 | |
| Compression unit (MW) | 4.5 | 6.4 | |
| Other utilities (MW) | 2.5 | 3 | — |
| Water recovered (%) | 90.7 | — | — |
| SPECCA (kJ/KgCO₂) | 0.6 | 1.4 | — |
| Process efficiency (%) | 78 | 73 | — |

A new approach to CO₂ capture for lime production is disclosed herein based on calcination in steam generated from the combustion of hydrogen and oxygen. This is estimated to have a similar capture efficiency to oxyfuel combustion, with 98.6% of the CO₂ captured by condensing the steam and separating it with a flash separator. It is also estimated that 90.7% of water can be recovered.

Compared to the oxyfuel process, the steam calcination process is estimated to become cost-effective when the price of hydrogen reaches approximately cost parity with natural gas on an energy basis. It is also estimated to reduce the cost of CO₂ transport and storage by around 23.9% over that for the oxyfuel process by avoiding combustion-generated CO₂. For the case in which fuel sells at a similar price in energy terms, the cost of lime from the steam calcination process is 25% cheaper than that for the oxyfuel process without an ASU and 8.5% with an ASU. This shows that calcination in steam results in significant additional advantages over simply burning the hydrogen in a conventional process due to the additional benefits of a lower calcination temperature.

The apparatus and processes described herein can also be used to calcine a wide range of carbonated and hydroxylated materials in a similar way. For example, the apparatus and processes described herein can also be used to produce cementitious material from clay. Steam which is released during the calcination of clays is mixed with the combustion products, which contain nitrogen from any air used in combustion, together with any CO₂ that would be produced from the combustion of any carbon in the fuel. Using the apparatus and processes described herein, this challenge can be avoided by replacing the air, traditionally used for combustion, with oxygen, and by replacing the fossil fuel with hydrogen, whilst also using steam as the calcining medium. This combination prevents diluting the steam that is released during calcination, with either nitrogen from the air, or with CO₂ from the fuel. It also requires addressing the same challenge of heat recovery as is described herein for limestone.

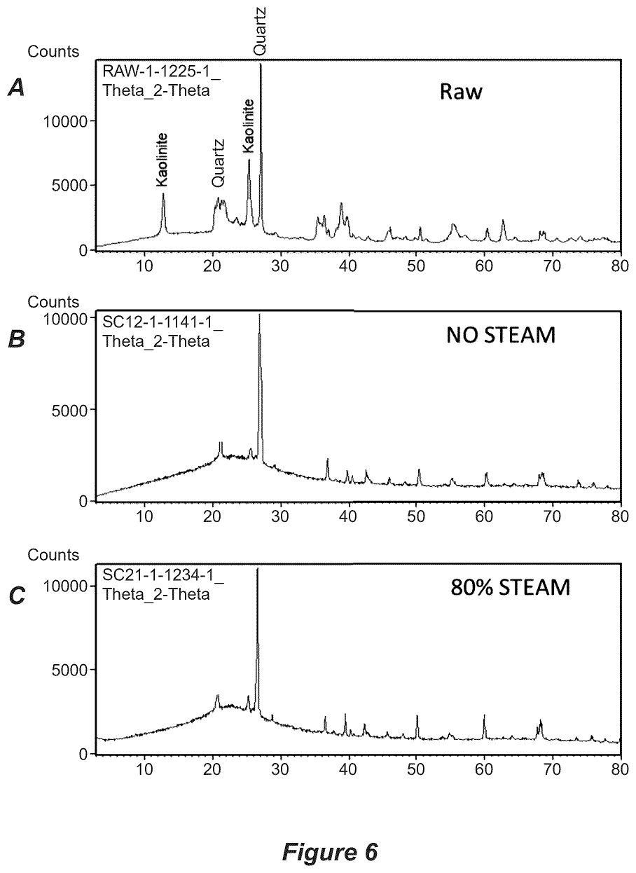

Any suitable clay can be calcined using the apparatus and processes described herein. Suitable clays include carbonates of iron, zinc and copper, or hydroxides of ores such as iron, typically called goethite. Each of these can be processed in a similar way to those described for limestone and clays, as will be known to one skilled in the art. The results for the calcination of a clay are shown in FIG. 6. The calcination was carried out at 800° C. for 1 hour. It can be seen that the peaks associated with kaolinite content of the raw sample are eliminated through calcination of clay both with and without steam, which indicates the conversion of kaolinite to metakaolinite. On the other hand, the quartz, as an inert phase, is not transformed during calcination in both cases of with and without steam. The percentage of dehydroxylation conversion (χ_{DH}) was also measured for the samples after four repeats based on the below equation:

$${χ}_{DH} = \frac{{m}_{0} - {m}_{c}}{{M}_{0}} \times 100$$

wherein, m₀ and m_{c} are the mass of sample before and after calcination, respectively. The measurements shows an χ_{DH}=11.7±0.4 for calcination without and an χ_{DH}=11.4±0.4 for calcination with 80% steam.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

### REFERENCES

[1]A. Mohammadinia, A. Arulrajah, H. Haghighi, and S. Horpibulsuk, “Effect of lime stabilization on the mechanical and micro-scale properties of recycled demolition materials,” Sustainable Cities and Society, vol. 30, pp. 58-65, 2017.
[2]A. Arulrajah, A. Mohammadinia, I. Phummiphan, S. Horpibulsuk, and W. Samingthong, “Stabilization of Recycled Demolition Aggregates by Geopolymers comprising Calcium Carbide Residue, Fly Ash and Slag precursors,” Construction and Building Materials, vol. 114, pp. 864-873, 2016.
[3]E. Benhelal, G. Zahedi, and H. Hashim, “A novel design for green and economical cement manufacturing,” Journal of Cleaner Production, vol. 22, no. 1, pp. 60-66, 2012.
[4]F. Carrasco-Maldonado, R. Sp6rl, K. Fleiger, V. Hoenig, J. Maier, and G. Scheffknecht, “Oxy-fuel combustion technology for cement production—State of the art research and technology development,” International Journal of Greenhouse Gas Control, vol. 45, pp. 189-199, 2016.
[5]J. M. Valverde, P. E. Sanchez-Jimenez, and L. A. Perez-Maqueda, “Limestone Calcination Nearby Equilibrium: Kinetics, CaO Crystal Structure, Sintering and Reactivity,” The Journal of Physical Chemistry C, vol. 119, no. 4, pp. 1623-1641, 2015.
[7]E. Benhelal, E. Shamsaei, and M. I. Rashid, “Challenges against CO2 abatement strategies in cement industry: A review,” J Environ Sci (China), vol. 104, pp. 84-101, June 2021.
[8]T. P. Hills, M. Sceats, D. Rennie, and P. Fennell, “LEILAC: Low Cost CO2 Capture for the Cement and Lime Industries,” Energy Procedia, vol. 114, pp. 6166-6170, 2017.
[9]Y. Yang, L. Wang, D. Xia, Z. Jiang, B. Jiang, and P. Zhang, “Novel Lime Calcination System for CO2 Capture and Its Thermal-Mass Balance Analysis,” ACS Omega, vol. 5, no. 42, pp. 27413-27424, Oct. 27 2020.
[10]L. K. Wang, Y.-T. Hung, and N. K. Shammas, Advanced physicochemical treatment technologies. Springer, 2007.
[11]G. D. Silcox, J. C. Kramlich, and D. W. Pershing, “A mathematical model for the flash calcination of dispersed calcium carbonate and calcium hydroxide particles,” Industrial & engineering chemistry research, vol. 28, no. 2, pp. 155-160, 1989.
[12]F. Garcia-Labiano, A. Abad, L. De Diego, P. Gayan, and J. Adanez, “Calcination of calcium-based sorbents at pressure in a broad range of CO2 concentrations,” Chemical engineering science, vol. 57, no. 13, pp. 2381-2393, 2002.
[13]M. Silakhori et al., “Effects of steam on the kinetics of calcium carbonate calcination,” Chemical Engineering Science, vol. 246, 2021.
[14]G. Giammaria and L. Lefferts, “Catalytic effect of water on calcium carbonate decomposition,” Journal of CO2 Utilization, vol. 33, pp. 341-356, 2019.
[15]Z.-H. Li, Y. Wang, K. Xu, J.-Z. Yang, S.-B. Niu, and H. Yao, “Effect of steam on CaO regeneration, carbonation and hydration reactions for CO2 capture,” Fuel Processing Technology, vol. 151, pp. 101-106, 2016.
[16]Y. Wang, S. Lin, and Y. Suzuki, “Limestone calcination with CO 2 capture (II): decomposition in CO 2/steam and CO 2/N 2 atmospheres,” Energy & fuels, vol. 22, no. 4, pp. 2326-2331, 2008.
[17]E. Berger, “Effect of Steam on the Decomposition of Limestone1, 1,” Industrial & Engineering Chemistry, vol. 19, no. 5, pp. 594-596, 1927.
[18]R. McIntosh, J. Sharp, and F. Wilburn, “The thermal decomposition of dolomite,” Thermochimica Acta, vol. 165, no. 2, pp. 281-296, 1990.
[19]W. Maclntire and T. Stansel, “Steam catalysis in calcinations of dolomite and limestone fines,” Industrial & Engineering Chemistry, vol. 45, no. 7, pp. 1548-1555, 1953. 20
[20]S. T. McCoy and E. S. Rubin, “An engineering-economic model of pipeline transport of CO2 with application to carbon capture and storage,” International journal of greenhouse gas control, vol. 2, no. 2, pp. 219-229, 2008.
[21]W. J. Schmelz, G. Hochman, and K. G. Miller, “Total cost of carbon capture and storage implemented at a regional scale: northeastern and midwestern United States,” Interface Focus, vol. 10, no. 5, p. 20190065, Oct. 6 2020.
[22]B. Metz, O. Davidson, H. De Coninck, M. Loos, and L. Meyer, IPCC special report on carbon dioxide capture and storage. Cambridge: Cambridge University Press, 2005.
[23]T. Grant and D. Morgan, “FE/NETL CO2 Saline Storage Cost Model (2017): User's Manual,” NETL2017.
[24]S. Gardarsdottir et al., “Comparison of Technologies for CO2 Capture from Cement Production—Part 2: Cost Analysis,” Energies, vol. 12, no. 3, 2019.
[25] Jordal et al., “CEMCAP-CO2 capture from cement production, D2.11 CEMCAP Strategic conclusions—progressing CO2 capture from cement towards demonstration,” 2019, Available: https://www.zenodo.org/record/2593135 #.XkJUSTH7SUk, Accessed on: 11/02/2020.
[26]M. Voldsund et al., “Comparison of Technologies for CO2 Capture from Cement Production—Part 1: Technical Evaluation,” Energies, vol. 12, no. 3, 2019.
[27]F. Carrasco-Maldonado, R. Sp6rl, K. Fleiger, V. Hoenig, J. Maier, and G. Scheffknecht, “Oxy-fuel combustion technology for cement production-state of the art research and technology development,” International Journal of Greenhouse Gas Control, vol. 45, pp. 189-199, 2016.
[28]F. Carrasco, S. Grathwohl, J. Maier, J. Ruppert, and G. Scheffknecht, “Experimental investigations of oxyfuel burner for cement production application,” Fuel, vol. 236, pp. 608-614, 2019.
[29]Y.-S. Kwon, K. B. Gerasimov, and S.-K. Yoon, “Ball temperatures during mechanical alloying in planetary mills,” Journal of alloys and compounds, vol. 346, no. 1-2, pp. 276-281, 2002.
[30]E. Tullberg, D. Peters, and T. Frejd, “The Heck reaction under ball-milling conditions,” Journal of organometallic chemistry, vol. 689, no. 23, pp. 3778-3781, 2004.
[31]L. Takacs and J. McHenry, “Temperature of the milling balls in shaker and planetary mills,” Journal of materials science, vol. 41, no. 16, pp. 5246-5249, 2006.
[32]M. Jafarian, M. Arjomandi, and G. J. Nathan, “The energetic performance of a novel hybrid solar thermal & chemical looping combustion plant,” Applied energy, vol. 132, pp. 74-85, 2014.
[33]P. E. Queneau and S. W. Marcuson, “Oxygen pyrometallurgy at copper cliff-A half century of progress,” Jom, vol. 48, no. 1, pp. 14-21, 1996.
[34]M. Babcock, “Oxy combustion processes for CO2 capture from power plant,” IEA, Report, no. 2005/9, 2005.
[35]D. P. Hanak and V. Manovic, “Combined heat and power generation with lime production for direct air capture,” Energy Conversion and Management, vol. 160, pp. 455-466, 2018.
[36]M. D. Aminu, S. A. Nabavi, C. A. Rochelle, and V. Manovic, “A review of developments in carbon dioxide storage,” Applied Energy, vol. 208, pp. 1389-1419, 2017.
[37]H. Ambarita and H. Sihombing, “The optimum intermediate pressure of two-stages vapor compression refrigeration cycle for Air-Conditioning unit,” in Journal of Physics: Conference Series, 2018, vol. 978, no. 1, p. 012098: IOP Publishing.
[38]E. De Lena, B. Arias, M. C. Romano, and J. C. Abanades, “Integrated Calcium Looping System with Circulating Fluidized Bed Reactors for Low CO2 Emission Cement Plants,” Available at SSRN 3817368, 2021.
[39]H. M. Kvamsdal, G. Haugen, and N. H. Eldrup, “Benchmarking of a Membrane Technology for Tail-end Application in a Cement Plant,” Available at SSRN 3820500, 2021.
[40]E. De Lena et al., “Comparative Analysis of the Oxyfuel and Calcium Looping Processes for Low-Carbon Cement Production,” Available at SSRN 3811561, 2021. 21
[41]U. DOE, “Energy and environmental profile of the US mining industry,” US Department of Energy Office of Energy Efficiency and Renewable Energy. Energiebilanz der Nuklearindustrie, 2002.
[42]H. Piringer, “Lime shaft kilns,” Energy Procedia, vol. 120, pp. 75-95, 2017.
[43]E. Taibi, H. Blanco, R. Miranda, and M. Carmo, “Green Hydrogen Cost Reduction,” 2020.
[44] AE02021, “U.S. Energy Information Administration, Annual Energy Outlook 2021”, Available: https://www.eia.gov/outlooks/aeo/pdf/03%20AE02021%20Natural %20gas.pdf.
[45]G. Energy, “CO2 status Report,” IEA (International Energy Agency): Paris, France, 2019.
[46]P. Hodgson, M. Sceats, A. Vincent, D. Rennie, P. Fennell, and T. Hills, “Direct separation calcination technology for carbon capture: demonstrating a low cost solution for the lime and cement industries in the LEILAC project,” in 14th Greenhouse Gas Control Technologies Conference Melbourne, 2018, pp. 21-26.

1. A calcination apparatus comprising:
a calciner;
a heated steam production apparatus to produce steam and provide heat and steam to the calciner; and
a separator to receive exhaust gas from the calciner and to condense steam from the exhaust gas and separate CO₂ gas from the water produced from the condensed steam.

2. The calcination apparatus as claimed in claim 1, further comprising a water recycling system for producing steam from the water produced from the condensed steam in the separator and feeding the produced steam to the calciner.

3. The calcination apparatus as claimed in claim 2, further comprising a heat exchanger for producing steam from the water produced from the condensed steam in the separator using heat from hot exhaust gases from the calciner.

4. The calcination apparatus as claimed in claim 1, further comprising a heat recovery system for preheating a raw material to be fed to the calciner.

5. The calcination apparatus as claimed in claim 4, wherein the heat recovery system is configured to transfer heat from hot calcined product to the raw material.

6. The calcination apparatus as claimed in claim 1, wherein the heated steam production apparatus comprises a combustion apparatus configured to produce steam and heat from oxygen and hydrogen.

7. The calcination apparatus as claimed in claim 1, wherein the heated steam production apparatus comprises a steam generator and a heater configured to produce high temperature steam using a suitable energy source.

8. An apparatus for lime (CaO) production, the apparatus comprising the calcination apparatus as claimed in claim 1.

9. An apparatus for cement clinker production, the apparatus comprising the calcination apparatus as claimed in claim 1 and a kiln.

10. An apparatus for production of cementitious material from clay, the apparatus comprising the calcination apparatus as claimed in claim 1.

11. A system for mitigating carbon dioxide levels during the manufacture of lime or cement clinker, the system comprising the calcination apparatus as claimed in claim 1.

12. A process for calcining a raw material to produce a calcined product, the process comprising:
introducing the raw material to a calciner; and
heating the raw material in the presence of steam in the calciner to produce a calcined product;
condensing steam from exhaust gas from the calciner; and
where used with a carbonate ore, separating CO₂ gas from the water produced from the condensed steam.

13. The process as claimed in claim 12, comprising producing steam from the water produced from the condensed steam in the separator and feeding the produced steam to the calciner.

14. The process as claimed in claim 13, comprising producing steam from the water produced from the condensed steam in the separator using heat from hot exhaust gases from the calciner.

15. The process as claimed in claim 12, comprising heating the raw material using heat from calcined product exiting the calciner.

16. The process as claimed in claim 12, comprising generating the steam used to heat the raw material in the calciner from combustion of oxygen and hydrogen.

17. The process as claimed in claim 12, generating the steam used to heat the raw material in the calciner using a suitable energy source.
